(19) United States
(12) Patent Application Publication
(10) Pub. No.: US 2004/0074352 A1
(43) Pub. Date: Apr. 22, 2004

(54) Adjustable anvil for a flat bearer ring die

(75) Inventor: Darold D. Tippey, Neenah, WI (US)

Correspondence Address: SCHWEGMAN, LUNDBERG, WOESSNER & KLUTH, P.A., P.O. BOX 2938, MINNEAPOLIS, MN, 55402, US

(73) Assignee: Kimberly-Clark Worldwide, Inc.

(21) Appl. No.: 10/277,293

(22) Filed: Oct. 21, 2002

(51) Int. Cl. B26D 1/15

(52) U.S. Cl. 83/13; 83/338

(57) ABSTRACT

A rotary cutting apparatus includes a cutter roll assembly and an anvil roll assembly. The cutter roll assembly includes a bearer ring. The anvil roll, which is includes a substantially cylindrical surface, is parallel with the bearing surface of the cutter roll. A multiple-position mechanism provides a plurality of relatively axially shifted positions for the cutter roll assembly and the anvil roll.

### TECHNICAL FIELD

Embodiments relate to a cutting apparatus. More particularly, embodiments relate to a rotary die-and-anvil cutting apparatus. In particular, embodiments relate to a system that includes a personal care article precursor web that is cut in a rotary die-and-anvil cutting apparatus that allows the cutting surface to be repositioned with respect to the anvil surface.

### TECHNICAL BACKGROUND

The cutting of a web can be done by a rotary die and anvil apparatus. For industrial applications, the rotary die and anvil apparatus cycles through a high number of revolutions as the die cuts the web against the anvil. Ordinary usage of the apparatus leads to a blunting of the rotary die and/or a wearing out of the anvil. In any event, as the cutting mechanism loses its ability to shear the web, either the rotary die or the rotary anvil, or both, needs replacing.

### SUMMARY

A cutting apparatus is disclosed. The cutting apparatus includes a cutter roll assembly and an anvil roll assembly. The cutter roll assembly includes a flat or right-angle (“right”) bearer ring. The anvil roll assembly includes a substantially cylindrical anvil roll. The right bearer ring interfaces at the anvil roll at a substantially parallel interface.

The anvil roll rotates about an anvil axis and presents an anvil surface to a cutter tip on the cutter roll assembly. The anvil roll both “walks” in relation to the cutter tip, and it axially shifts relative to the cutter tip to minimize wear. In one embodiment, the cutter tip is a refractory metal carbide compound that has a hardness that is greater than the hardness of the anvil roll.

Axial shifting of the anvil roll relative to the cutter tip can be carried out by shifting the anvil roll alone, shifting the cutter roll assembly alone, of by shifting both. Shifting can be one of a discrete shift and a substantially continuous shift.

A method embodiment includes presenting a cutter roll assembly against a cylindrical anvil roll at a first position. Next, the method includes operating the cutter roll assembly and the anvil roll at the first position to achieve a first amount of latitudinal cut anvil wear. Next, the method includes axially shifting the cutter roll assembly and the anvil roll to a subsequent position relative to the first position. And the method includes operating the cutter roll assembly and the anvil roll assembly at the subsequent position.

In one method embodiment, cutter roll assembly includes a right-angle bearer ring. In this embodiment, operating the cutter roll assembly further includes at least one of transferring torque through the bearer ring and driving at least one of the cutter roll assembly and the anvil roll assembly.

One embodiment relates to a system. The system includes an embodiment of a cutting apparatus as set forth herein, and a web. In one embodiment, the web is a liquid-absorbing medium or the like. In one embodiment the web is an infant care garment precursor. In one embodiment, the web is a childcare garment precursor. In one embodiment, the web is an adult care garment precursor. In one embodiment, the web is a feminine care garment precursor. In one embodiment, the web is a non-woven web precursor. In one embodiment, the web is a woven web precursor or the like. In one embodiment, the “web” is an other material such as wood, metal, plastic, organic, inorganic, organic/inorganic laminate or composite, and others.

These and other embodiments are set forth more fully in the balance of the disclosure.

### BRIEF DESCRIPTION OF THE DRAWINGS

In order to understand the manner in which embodiments are obtained, a more particular description of various embodiments briefly described above will be rendered by reference to the appended drawings. Understanding that these drawings depict only typical embodiments that are not necessarily drawn to scale and are not therefore to be considered to be limiting of its scope, the embodiments will be described and explained with additional specificity and detail through the use of the accompanying drawings in which:

FIG. 1 is a cross section of an adjustable anvil system according to an embodiment;

FIG. 2 is a cross section of an anvil roll according to an embodiment;

FIG. 3 is a side elevation of the anvil roll depicted in FIG. 2;

FIG. 4 is a cross section of the anvil roll depicted in FIG. 3, taken from another view; and

FIG. 5 is a process flow diagram according to an embodiment.

### DETAILED DESCRIPTION

The following description includes terms, such as first, second, etc. that are used for descriptive purposes only and are not to be construed as limiting. In the following detailed description, reference is made to the accompanying drawings, which form a part hereof. These drawings show, by way of illustration, specific embodiments in which the invention may be practiced. In the drawings, some of the like numerals describe substantially similar components throughout the several views. These embodiments are described in sufficient detail to enable those skilled in the art to practice the invention. Other embodiments may be used and structural changes may be made without departing from the scope of the several embodiments.

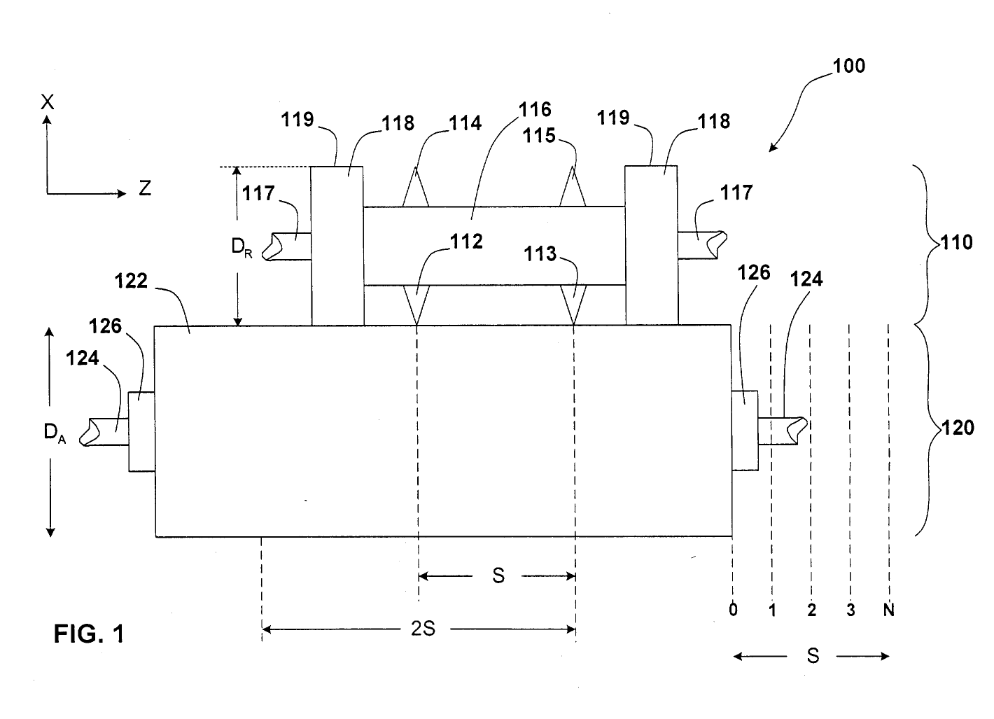

FIG. 1 is a cross section of a cutting apparatus 100 according to an embodiment. The cutting apparatus 100 includes a cutter roll assembly 110 and an anvil roll assembly 120. The cutter roll assembly 110 includes a flat or right-angle (“right”) bearer ring 118 with a bearer ring diameter D_{R}. The anvil roll assembly 120 includes a substantially cylindrical anvil roll 122 with an anvil roll diameter D_{A}. In one embodiment, the bearer ring diameter D_{R} is different from the anvil roll diameter D_{A}. In one embodiment, D_{R} is larger than D_{A}. In one embodiment, D_{R} is smaller than D_{A}. In one embodiment, D_{R} and D_{A} are substantially equal.

In one embodiment, the cutter roll assembly includes a die of a first material of a first hardness, and the anvil assembly includes a second material of a second hardness. In one embodiment the first hardness is greater than the second hardness. In this embodiment, the die wears longer and the anvil roll assembly is configured to wear out faster. Accordingly, since the anvil roll assembly is substantially cylindrical, it is easer to machine and/or recondition than the die.

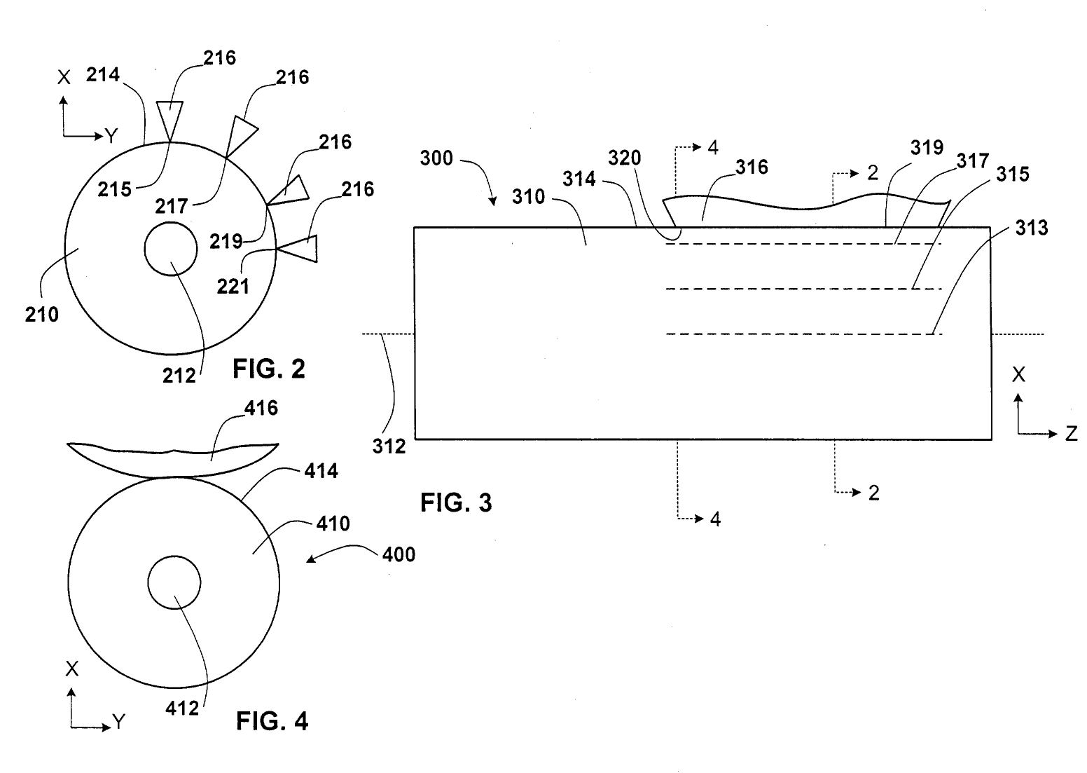

FIG. 2 is a cross-section of an anvil roll configuration 200 that illustrates various positions of a cutter tip during operation to minimize anvil wear. One method of limiting wear is to create a walking anvil configuration. By “walking anvil” it is meant that as the anvil roll 210 completes a revolution, cutter tip die contact with the anvil roll 210 is at least patterned to not strike the anvil roll 210 at the same location as the previous strike.

The anvil roll 210 rotates about an anvil axis 212 and presents an anvil surface 214 to a cutter tip 216. The cutter tip 216 is depicted as the same structure that contacts the anvil roll 210 at the anvil roll surface 214 in four occurrences. First, the cutter tip 216 contacts the anvil roll surface 214 at 215. Next and second as the cutter roll assembly (not pictured) rotates, the cutter tip 216 contacts the anvil roll surface 214 at 217. Next and third as the cutter roll assembly (not pictured) rotates, the cutter tip 216 contacts the anvil roll surface 214 at 219. Next and fourth as the cutter roll assembly (not pictured) rotates, the cutter tip 216 contacts the anvil roll surface 214 at 221. Assuming in this embodiment that the anvil roll 210 rotates clockwise in the FIG., the cutter tip 216 is depicted as contacting the anvil roll 210 in a progressively advancing contact pattern. However, this embodiment is not limiting, and other contact patterns can be selected by varying D_{R} in relation to D_{A} or vise versa.

Thus for each revolution, the cutter tip 216 “walks” or changes its contact point with the anvil roll surface 214. No web is depicted. In one embodiment where the bearer ring diameter D_{R} is significantly different from the anvil roll diameter D_{A} (FIG. 1), the walking anvil effect can result in a substantially random but also substantially even wear pattern upon the anvil roll 210.

Referring again to FIG. 1, the cutter roll assembly 110 includes a series of cutter tips 112, 113, 114, and 115. Additionally, the cutter roll assembly 110 includes a cutter roll 116 and the bearer ring 118 that rotate around a cutter roll axial mount 117.

The cutter tips 112, 113, 114, and 115 are shown in cross-section as they make a series of cuts upon a web (not pictured) as it is sheared between the cutter tips 112 and 113 and the anvil roll 122. As the anvil roll 122 rotates, the cutter tips 112 and 113 are depicted in a “snapshot” view as making two latitudinal contacts or cuts upon the anvil roll 122 as it is rotated.

In one embodiment, the cutter tips 112, 113, 114, and 115 are part of a single die that is a three-dimensional cutting mechanism wrapped around the cutter roll 116. In one embodiment, the cutter tips 112, 113, 114, and 115 are part of a closed loop that rotates in the machine direction of the cutting apparatus 100 and cuts out a discrete article. In one embodiment, the cutter tips 112, 113, 114, and 115 are part of a die that includes the cutter tips 112, 113, 114, and 115 as an insert, or as pieced-together inserts that have been inserted into a cutter roll 116. In this embodiment, the insert 112, 113, 114, and 115 is conformally positioned around the cutter roll 116 that can be a cylinder. In another embodiment, the cutter tips 112, 113, 114, and 115 are part of an integral unit that is made of a single piece including the cutter roll 116 and the cutter tips 112, 113, 114, and 115.

In one embodiment, the cutter tips 112, 113, 114, and 115 are made of a hardened material such as a refractory metal compound. In one embodiment, the refractory metal compound is a refractory metal carbide. In one embodiment, the refractory metal compound is a refractory metal silicide. In one embodiment, the refractory metal compound is a refractory metal carbide silicide. In one embodiment, the refractory metal compound is a refractory metal nitride. In one embodiment, the refractory metal compound is a refractory metal and cermet compound. In one embodiment, the refractory metal is selected from chromium (Cr), molybdenum (Mo), tungsten (W), or combinations thereof. In one embodiment, the refractory metal is selected from titanium (Ti), zirconium (Zr), hafnium (Hf), or combinations thereof. In one embodiment, the refractory metal is selected from vanadium, (V), niobium (Nb), tantalum, (Ta), or combinations thereof. In one embodiment, the refractory metal is selected from cobalt (Co), rhodium (Rh), iridium (Ir), or combinations thereof. In one embodiment, the refractory metal is selected from nickel (Ni), palladium (Pd), platinum (Pt), or combinations thereof. In one embodiment, the refractory metal compound is a tungsten carbide compound. Other hardened materials can be used for the cutter tips according to conventional usage.

The materials of the anvil roll 120 are usually less hard than the materials of the cutter tips 112, 113, 114, and 115. In one embodiment, however, the hardness of the anvil roll and the cutter tip are substantially the same. In one embodiment, a hardness metric such as the Brinell hardness is used to compare hardness of the anvil roll 120 to the cutter tips 112, 113, 114, and 115. In one embodiment, the cutter tips 112, 113, 114, and 115 have a Brinell hardness that is harder than the anvil roll 120 by factor of about 2 or greater. In one embodiment, the cutter tips 112, 113, 114, and 115 have a Brinell hardness that is harder than the anvil roll 120 by factor of about 1.5. In one embodiment, the cutter tips 112, 113, 114, and 115 have a Brinell hardness that is harder than the anvil roll 120 by factor of about 1.1.

The bearer ring 118 includes a bearing surface 119 that contacts the anvil roll 122. In one embodiment, contact is made by mating of the two parallel surfaces of the bearer surface 119 and the anvil roll 122.

In one embodiment, the bearer ring 118 has a configuration of a washer shape. By “washer shape”, it is meant that the dimension of the bearing surface 119 is less than the bearer ring diameter D_{R}. In one embodiment, the bearer ring 118 has a configuration of a cylindrical shape. By “cylindrical shape”, it is meant that the dimension of the bearing surface 119 is greater than or equal to the bearer ring diameter D_{R}. In one embodiment, a bearer ring 118 that has a cylindrical shape has a lower overall wear on areas of the anvil roll 122 than a bearer ring 118 with a washer shape.

The anvil roll assembly 120 includes the anvil roll 122 as it is mounted on an axial mount 124. In one embodiment, the axial mount 124 is a shaft that is configured to rotate and thereby to allow the anvil roll 122 to rotate. Although the axial mount 124 is depicted as part of the anvil roll assembly 120, it becomes clear to one of ordinary skill in the art that an alternative axial mount can be used to allow the cutter roll assembly 110 to rotate. Other axial mounts include a rolling support that cradles the anvil roll 122 such as two supporting rollers. Other axial mounts include a ball-bearing raceway mount that encloses the anvil roll 122 at a location that is out of the way of the cutter assembly 110. By reading this disclosure, one of ordinary skill in the art can apply other axial mounts to the cutter apparatus 100.

FIG. 1 depicts one embodiment of securing the anvil roll 122 to the axial mount 124 by use of a locking collar 126. In this embodiment, the anvil roll 122 is repositionable under the cutter roll assembly 110 by unlocking the locking collar 126 and axially shifting the anvil roll 122. In this embodiment, the locking collar 126 and the axial mount 124 are part of a multiple-position mechanism that is used to position the anvil roll assembly 120 below the cutter roll assembly 110. In other embodiments, the multiple-position mechanism provides a plurality of relatively axially shifted positions for the cutter roll assembly 110 and the anvil roll assembly 120. In another embodiment, the locking collar 126 is positioned to hold the anvil roll 122, and an axial shift is done by translational moving of the axial mount 124.

In one embodiment, the axial mount 124 is moved incrementally after an amount of wear is experienced, either at least one of the cutter tips 112, 113, 114, and 115, or at the anvil roll 122.

In one embodiment, the axial shift is done by using a multiple-position mechanism to axially shift the cutter roll assembly 110. In one embodiment, the multiple-position mechanism includes a shaft (not pictured) that is positioned axially within the cutter roll assembly 110. In one embodiment, the multiple-position mechanism includes the shaft that is the axial mount 124 of the anvil roll assembly 120. In one embodiment, the multiple-position mechanism includes the shaft (not pictured) that is positioned axially within the cutter roll assembly 110, and it includes the shaft that is the axial mount 124 of the anvil roll assembly 120.

In one embodiment, the shaft is slideably anchored such that the cutter roll assembly 110 and the anvil roll assembly 120 can be repositioned with respect to each other in order to present a new anvil wear surface for the cutter tips 112, 113, 114, and 115. In one embodiment, at least one of the cutter roll assembly 110 and the anvil roll 122 is slideably anchored such that the cutter roll assembly 110 and the anvil roll 122 can be repositioned with respect to each other in order to present a new anvil wear surface for the cutter tips 112, 113, 114, and 115.

In one embodiment, the relative position of the cutter roll assembly 110 and the anvil roll assembly 120 is incrementally positionable. By “incrementally positionable”, it is meant that the relative position can be changed by one of discrete axial shifts, or substantially continuous axial shifts. In one embodiment, a discrete axial shift includes shift by use of a ratchet mechanism. In one embodiment, the ratchet mechanism, as is conventionally known, is combined with the cutting apparatus 100 depicted in FIG. 1. In a method embodiment, the ratchet mechanism is actuated, and the position of the cutter roll assembly 110 is shifted relative to the anvil roll assembly. In FIG. 1, a position “0” is depicted with the anvil roll assembly 120 being the device to be axially shifted. At the position “1” a discrete axial shift has been accomplished. Further axial shifts can include the anvil roll assembly repositioning to positions “2”, “3”, and up to position “N”. Additionally, as set forth herein, the axial shift can be an axial shift of the cutter roll assembly 110, or a combination of the cutter roll assembly 110 in a first cross direction and the anvil roll assembly in a second cross direction that is opposite the first cross direction.

It is noted in FIG. 1 a distance S is depicted between the cutter tip 112 and the cutter tip 113. The distance S defines one dimension of a fresh anvil surface upon the anvil roll 122, that is not overlapped as the relative positions are axially changed for the cutter roll assembly 110 and the anvil roll assembly 120. It is also noted that the distance 2S is the approximate useful anvil surface for the anvil roll 122 before a latitudinal cut overlap occurs. A latitudinal cut is orthogonal to the depiction in FIG. 1, and parallel to the Y-axis. Further, the distance S is also the distance that the relative position can shift. In one embodiment, “N” discrete positions are provided to shift the anvil roll 122 or the anvil roll assembly 120 beneath the cutter roll assembly 110.

In one embodiment, a discrete axial shift is done after a preselected amount of machine time has elapsed. In one embodiment, a discrete axial shift is done after a preselected number of revolutions has been completed. In one embodiment, a discrete axial shift is done after a preselected amount of web has been cut. In one embodiment, a discrete axial shift is done after a preselected cut quality is observed on the web. For example, the sheared edges of the web can be examined. Other cut qualities known in the art can be used as guidelines for triggering an axial shift. Once a certain shear quality is no longer observed, a discrete axial shift is done.

FIG. 3 is a side elevation of an anvil configuration 300 according to an embodiment. It is noted that FIG. 2 is taken from FIG. 3 along the line 2-2. The anvil configuration 300 includes an anvil roll 310 with an anvil surface 314. The anvil roll 310 rotates about an axis 312 (the Z-axis). As the anvil roll 310 rotates about the axis 312, a portion of a cutter tip 316 is depicted as it makes contact with the anvil surface 314. The cutter tip 316 is depicted as having made a series of longitudinal contacts (parallel to the Z-axis) with the anvil surface 314 as the anvil roll 310 rotates about the axis 312. In this non-limiting embodiment, the cutter tip 316 makes a retrogressive walking pattern as it contacts first at 313, next at 315, next at 317, and as depicted currently at 319.

FIG. 4 is a cross section of the anvil roll depicted in FIG. 3, taken from another view as compared to the view in FIG. 2. This view is taken from FIG. 3 along the line 4-4 to illustrate a latitudinal cut (parallel to the Y-axis) of a cutter tip 416. The section line 4-4 therefore cuts through at an edge 320 of the cutter tip 316 (FIG. 3). According to another embodiment, another method of limiting wear is to create an axially shifting anvil roll configuration as set forth herein.

The anvil roll 410 rotates about an anvil axis 412 (the Z-axis) and presents an anvil surface 414 to a cutter tip 416. The cutter tip 416 is depicted as rolling and making a latitudinal cutting contact (parallel to the Y-axis) with the anvil surface.

According to an embodiment, the cutter tip 416 changes its contact point with the anvil roll surface 414 by an axial shift being accomplished. No web is depicted. In one embodiment, the axial shift is carried out substantially continuously. In one embodiment, the substantially continuous axial shift is accomplished by a screw (not pictured) that rotates and axially shifts at least one of the cutter roll assembly 110 (FIG. 1) and the anvil roll assembly 120 (FIG. 1) relative to each other. In one embodiment, the screw is a conventional screw mechanism that advances at a rate that is related to the number of revolutions that occur in the machine direction. In one embodiment, the screw is a conventional screw mechanism that advances at a rate that is related to the service time of the anvil roll. In one embodiment, the screw causes an oscillating axial shift behavior after a manner that partially mimics the walking anvil embodiment. However, since the axial shift represents a cross-directional shift relative to the web, the axial shift can be controlled to assure quality of the articles that are cut from the web.

In one embodiment, the substantially continuous axial shift is accomplished by a cam (not pictured) that rotates and axially shifts at least one of the cutter roll assembly 110 (FIG. 1) and the anvil roll assembly 120 (FIG. 1) relative to each other. In one embodiment, the cam causes an oscillating axial shifting behavior after a manner that analogously mimics wear caused by the walking anvil embodiment. However, since the axial shift represents a cross-direction shift relative to the web as the web flows in the machine direction, the rate of the axial shift can be controlled to assure quality of the articles that are cut from the web.

A method embodiment includes presenting a cutter roll assembly against a cylindrical anvil roll at a first position. Next, the method includes operating the cutter roll assembly and the anvil roll at the first position to achieve a first amount of latitudinal cut anvil wear. Next, the method includes axially shifting the cutter roll assembly and/or the anvil roll to a subsequent position relative to the first position. And the method includes operating the cutter roll assembly and the anvil roll assembly at the subsequent position.

A specific application of this method embodiment is depicted in FIG. 1. First, a cutter roll assembly 110 is presented against a cylindrical anvil roll assembly 120 at a first position “0”. Next, the method includes operating the cutter roll assembly 110 and the anvil roll assembly 120 at the first position “0” to achieve a first amount of latitudinal anvil wear. Next, the method includes axially shifting the cutter roll assembly 110 and the anvil roll assembly 120 to a subsequent position “1” relative to the first position “0”. And the method includes operating the cutter roll assembly 110 and the anvil roll assembly 120 at the subsequent position “1”. The axial shifting can be substantially continuous or it can be a discrete shift.

In one method embodiment, cutter roll assembly includes a right-angle bearer ring. In this embodiment, operating the cutter roll assembly further includes at least one of transferring torque through the bearer ring and driving at least one of the cutter roll assembly and the anvil roll assembly. In an illustrative embodiment related to FIG. 1, torque can originated at the cutter roll assembly 110, at the anvil roll assembly 120, or both.

In another method embodiment, axially shifting the cutter roll assembly and the anvil roll assembly to a subsequent position relative to the first position includes maintaining the cutter roll assembly in a fixed machine direction, and shifting the anvil roll assembly in a cross direction. In an illustrative embodiment related to FIG. 1, this represents a shift of the anvil roll 122 to a new position. This shift can be either discrete or substantially continuous as set forth herein.

In an alternative method, shifting is accomplished by shifting the cutter roll assembly and maintaining the anvil roll assembly in a fixed machine direction, and shifting the cutter roll assembly in a cross direction.

In another alternative method, axially shifting the cutter roll assembly and the anvil roll assembly to a subsequent position relative to the first position includes shifting the anvil roll assembly in a first cross direction, and shifting the cutter roll assembly in a second cross direction that is different from the first cross direction. In another method embodiment, no cutting is carried out. However, an impressed pattern is made in the web by the “cutter” roll being impressed against the anvil roll. Whether the web is cut or merely deflected by an impression depends upon the application.

One embodiment relates to a system. The system includes an embodiment of the cutting apparatus such as is depicted in FIG. 1. Additionally the system includes a web. In one embodiment, the web is a liquid-absorbing medium or the like. In one embodiment the web is an infant care garment precursor or the like, such as for a HUGGIES® product or the like made by Kimberly-Clark Corporation of Neenah, Wis. In one embodiment, the web is a childcare garment precursor or the like, such as for a PULL-UPS® product or the like, also made by Kimberly-Clark Corporation. In one embodiment, the web is an adult care garment precursor or the like, such as for a DEPEND® product or the like, also made by Kimberly-Clark Corporation. In one embodiment, the web is a feminine care garment precursor or the like, such as for a KOTEX® product or the like, also made by Kimberly Clark Corporation. In one embodiment, the web is a non-woven web precursor or the like, such as for a KLEENEX® product or the like, also made by Kimberly-Clark Corporation. In one embodiment, the web is a woven web precursor or the like.

Other materials are useful to be cut by the cutting apparatus 100. In one embodiment, the web is a non-woven web precursor. In one embodiment, the web is a woven web precursor or the like. In one embodiment, the “web” is an other material such as wood, wood products, and the like. In one embodiment, the “web” is an other material such as metal, metal products, and the like. In one embodiment, the “web” is an other material such as plastic, plastic products, and the like. In one embodiment, the “web” is an other material such as organic, organic products, and the like. In one embodiment, the “web” is an other material such as inorganic, inorganic products, and the like. In one embodiment, the “web” is an other material such as an organic/inorganic laminate or composite and the like. By reading this disclosure, it becomes clear that another embodiment includes a “web” is any other material that is conducive to being processed according to the various embodiments set forth in this disclosure.

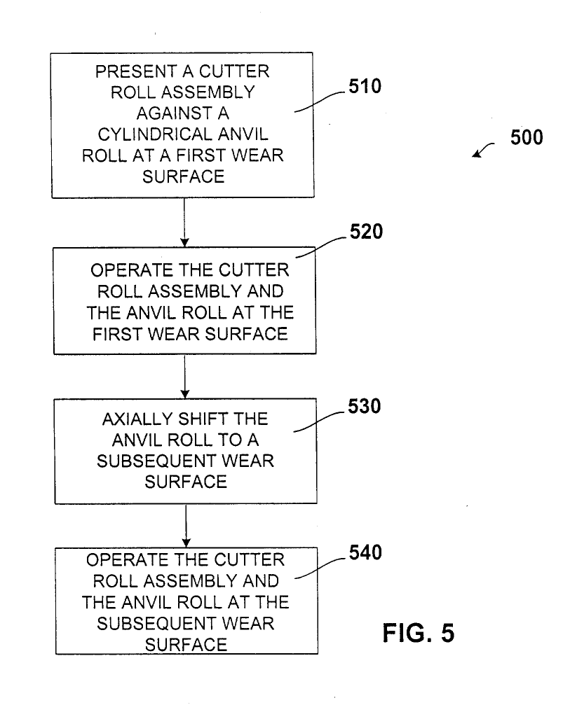

FIG. 5 is a process flow diagram according to an embodiment. The process 500 includes an axial shift of the cutter roll assembly and the anvil roll relative to each other. At 510, a cutter roll assembly is presented against a cylindrical anvil roll at a first wear surface. At 520 the cutter roll assembly and the anvil roll are operated at the first wear surface. At 530 the anvil roll is axially shifted, relative to the cutter roll assembly or vise versa, to a second wear surface. At 540, the cutter roll assembly and the anvil roll are operated at the second wear surface.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is.

1. A method comprising:
presenting a cutter roll assembly against a cylindrical anvil roll at a first position;
operating the cutter roll assembly and the anvil roll at the first position to achieve a first amount of latitudinal anvil wear;
axially shifting the cutter roll assembly and the anvil roll to a subsequent position relative to the first position; and
operating the cutter roll assembly and the anvil roll at the subsequent position.

2. The method according to claim 1, wherein the cutter roll assembly includes a right-angle bearer ring, the method operating the cutter roll assembly further includes at least one of transferring torque through the bearer ring and driving at least one of the cutter roll assembly and the anvil roll.

3. The method according to claim 1, wherein axially shifting the cutter roll assembly and the anvil roll to a subsequent position relative to the first position includes maintaining the cutter roll assembly in a fixed machine direction, and shifting the anvil roll in a cross direction.

4. The method according to claim 1, wherein axially shifting the cutter roll assembly and the anvil roll to a subsequent position relative to the first position includes maintaining the anvil roll in a fixed machine direction, and shifting the cutter roll assembly in a cross direction.

5. The method according to claim 1, wherein axially shifting the cutter roll assembly and the anvil roll to a subsequent position relative to the first position includes shifting the anvil roll in a first cross direction, and shifting the cutter roll assembly in a second cross direction that is different from the first cross direction.

6. The method according to claim 1, wherein axially shifting the cutter roll assembly and the anvil roll to a subsequent position relative to the first position includes a discrete axial shift.

7. The method according to claim 1, wherein axially shifting the cutter roll assembly and the anvil roll to a subsequent position relative to the first position includes a discrete axial shift, wherein the discrete axial shift is carried out by a contrivance selected from a screw, a ratchet, a cam, a locking collar, and combinations thereof.

8. The method according to claim 1, wherein axially shifting the cutter roll assembly and the anvil roll to a subsequent position relative to the first position includes a continuous axial shift.

9. The method according to claim 1, further including:
supplying a web to the cutter roll assembly and the anvil roll; and
impressing the web between the cutter roll assembly and the anvil roll.

10. The method according to claim 1, further including:
supplying a web to the cutter roll assembly and the anvil roll; and
impressing the web between the cutter roll assembly and the anvil roll, wherein the web is selected from an infant care garment precursor, a child care garment precursor, an adult care garment precursor, a feminine care garment precursor, a woven web, and a non-woven web or other material.

11. A method comprising:
presenting a cutter roll assembly against a cylindrical anvil roll at a first wear surface, wherein the cutter roll assembly includes a right bearer ring;
operating the cutter roll assembly and the anvil roll at the first wear surface;
axially shifting the anvil roll to a subsequent wear surface relative to the first wear surface; and
operating the cutter roll assembly and the anvil roll at the subsequent wear surface.

12. The method according to claim 11, the method operating the cutter roll assembly further includes at least one of transferring torque through the bearer ring and driving at least one of the cutter roll assembly and the anvil roll.

13. The method according to claim 11, wherein axially shifting the anvil roll to a subsequent wear surface relative to the first wear surface is selected from a discrete axial shift, a continuous axial shift, and a combination thereof.

14. An apparatus comprising:
a cutter roll assembly including a bearer ring with a bearing surface;
an anvil roll assembly including a substantially cylindrical surface that is parallel with the bearing surface; and
a multiple-position mechanism that provides a plurality of relatively axially shifted positions for the cutter roll assembly and the anvil roll.

15. The apparatus according to claim 14, wherein the multiple-position mechanism includes a shaft that is positioned axially within one of the cutter roll assembly and the anvil roll, wherein the shaft is slideably anchored.

16. The apparatus according to claim 14, wherein the multiple-position mechanism includes a shaft that is positioned axially within one of the cutter roll assembly and the anvil roll, wherein the shaft is slideably anchored, and wherein the shaft is incrementally positionable.

17. The apparatus according to claim 14, wherein the bearer ring includes a right shape is selected from a right cylinder and a right washer.

18. The apparatus according to claim 14, the cutter roll assembly further including:
a die, wherein the die is selected from an integral unit of a cutting material, and an insert conformally positioned around a cutter roll.

19. The apparatus according to claim 14, wherein the bearer ring includes a first diameter and the anvil roll includes a second diameter, wherein the first diameter and the second diameter are not equal.

20. A system comprising:
a web;
a cutting apparatus that is positioned in a machine direction relative to the web, wherein the cutting apparatus includes:
a cutter roll assembly including a bearer ring with a bearing surface;
an anvil roll assembly including a substantially cylindrical anvil roll that is parallel with the bearing surface; and
a multiple-position mechanism that provides a plurality of relatively cross-direction shifted positions for the cutter roll assembly and the anvil roll.

21. The system according to claim 20, wherein the multiple-position mechanism actuates the anvil roll.

22. The system according to claim 20, wherein the multiple-position mechanism is actuated from one of a substantially continuous position adjustor and a discrete position adjustor.

23. The system according to claim 20, wherein the web includes a liquid-absorbing medium.

24. The system according to claim 20, wherein the web includes a liquid-absorbing medium, and wherein the web is selected from an infant care garment precursor, a child care garment precursor, an adult care garment precursor, a feminine care garment precursor, a woven web, and a non-woven web or other material.

25. The system according to claim 20, wherein the cutter roll assembly includes a die of a first material of a first hardness, wherein the anvil assembly includes a second material of a second hardness, wherein the first hardness is greater than the second hardness.

26. The system according to claim 20, wherein the cutter roll assembly includes a die of a first material of a first hardness, wherein the anvil assembly includes a second material of a second hardness, wherein the first hardness is greater than the second hardness by a factor of about 2.

27. The system according to claim 20, wherein the cutter roll assembly includes a die of a first material of a first hardness, wherein the anvil assembly includes a second material of a second hardness, wherein the first hardness is greater than the second hardness by a factor of about 1.5.

28. The system according to claim 20, wherein the cutter roll assembly includes a die of a first material of a first hardness, wherein the anvil assembly includes a second material of a second hardness, wherein the first hardness is greater than the second hardness by a factor of about 1.1.
